(19) United States
(12) Patent Application Publication
(10) Pub. No.: US 2013/0102241 A1
(43) Pub. Date: Apr. 25, 2013

(54) TARGETED CONTENT INSERTION FOR DEVICES RECEIVING RADIO BROADCAST CONTENT

(71) Applicant: LAZER SPOTS, LLC, Chicago, IL (US)

(72) Inventors: Christopher F. DEVINE, Winnetka, IL (US); William R. HIEATT, Colleyville, TX (US); Richard J. BONICK, Evanston, IL (US)

(73) Assignee: LAZER SPOTS, LLC, Chicago, IL (US)

(21) Appl. No.: 13/706,812

(22) Filed: Dec. 6, 2012

Related U.S. Application Data
(63) Continuation-in-part of application No. 13/626,969, filed on Sep. 26, 2012.
Application No. 13/626,969 is a continuation-in-part of application No. 13/245,482, filed on Sep. 26, 2011.
Application No. 13/245,482 is a continuation-in-part of application No. 12/879,081, filed on Sep. 10, 2010.
(60) Provisional application No. 61/567,261, filed on Dec. 6, 2011.
(60) Provisional application No. 61/368,509, filed on Jul. 28, 2010.
(60) Provisional application No. 61/241,790, filed on Sep. 11, 2009.

(51) Int. Cl. H04H 20/86

(52) U.S. Cl. CPC H04H 20/86
USPC 455/3.06

(57) ABSTRACT

Radio broadcasting equipment is provided that enables targeted radio broadcast advertisement delivery in a radio broadcast area wherein localized auxiliary content may be transmitted to a user device prior to or during transmission of broadcasted audio streams and output to the user via the user device at a prescribed point in time that is triggered based on an inaudible tone included in the broadcasted audio stream. Selection of the auxiliary content may be based on location information determined by the user device and/or preference information input by the user.

### CROSS REFERENCE TO RELATED APPLICATIONS

This patent application claims priority to U.S. Provisional Patent Application No. 61/567,261, filed Dec. 6, 2011, and is a continuation-in-part of U.S. patent application Ser. No. 13/626,969, filed Sep. 26, 2012, which is a continuation-in-part of U.S. patent application Ser. No. 13/245,482, filed Sep. 26, 2011, which is a continuation-in-art of U.S. patent application Ser. No. 12/879,081, filed Sep. 10, 2010, which relies for priority on U.S. Provisional Patent Application No. 61/368,509, filed Jul. 28, 2010, and U.S. Provisional Patent Application No. 61/241,790, filed Sep. 11, 2009, the disclosures of which are incorporated herein by reference in their entirety.

### FIELD OF THE INVENTION

Disclosed embodiments are directed, generally, to radio broadcasting equipment, systems, methodologies, software code and software applications that enable receipt and output of targeted (e.g., localized or focused) radio broadcast delivery in a radio broadcast area.

### DESCRIPTION OF THE RELATED ART

Radio broadcasters obtain revenue by selling advertising commercial time, wherein the commercials, or “spots” are incorporated into the content broadcast by the radio broadcaster in a broadcasting listening area. Typically, such broadcasters' listening areas are associated with a metropolitan area or geographic region and commercial time is sold to advertisers within that area or region.

However, more and more users are listening to broadcast radio on non-traditional user devices such as their mobile phones, smart phones, personal computers, tablets, digital audio recorders, digital video recorders, etc., which have installed and are running software applications that enable receipt and output of radio broadcast content. As in conventional radio broadcasting, the value of commercial time is, in part, based on the number of listeners that are potentially hearing a commercial; nevertheless, the effectiveness of those commercials in persuading a listener to partake of an advertised product or service or visit an advertiser's location may be based, at least in part, on the availability of the advertiser's product, service or location to a listener, and the interest of the listener. Thus, although a radio station listener may hear an advertiser's commercial, the likelihood that the listener may purchase the advertiser's product/service or visit the advertiser's location is at least in part based on the availability of advertiser's product/service, proximity of the advertiser's location and personal interests of the listener.

### SUMMARY

The following presents a simplified summary in order to provide a basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to the more detailed description below.

In accordance with at least one disclosed embodiment, radio broadcasting equipment, systems, methodologies, software code and software applications are provided that enable targeted radio broadcast advertisement delivery in a radio broadcast area wherein localized auxiliary content may be transmitted to a user device prior to or during transmission of broadcasted audio streams and output to the user via the user device at a prescribed point in time that is triggered based on an inaudible tone included in the broadcasted audio stream. Selection of the auxiliary content may be based on location information determined by the user device and/or preference information input by the user.

### BRIEF DESCRIPTION OF THE DRAWINGS

A more compete understanding of the present invention and the utility thereof may be acquired by referring to the following description in consideration of the accompanying drawings, in which like reference numbers indicate like features, and wherein:

FIG. 1 illustrates one example of a radio broadcast listening area in which localized or focused auxiliary content can be delivered to a plurality of user devices on one or more frequencies and inserted into an audio stream output by the user devices.

FIG. 2 illustrates one example of a user device that may be used to listen to radio broadcast auxiliary content and localized or focused auxiliary content may be inserted into the output audio stream in accordance with one or more of the illustrated embodiments.

### DETAILED DESCRIPTION

The description of specific embodiments is not intended to be limiting of the present invention. To the contrary, those skilled in the art should appreciate that there are numerous variations and equivalents that may be employed without departing from the scope of the present invention. Those equivalents and variations are intended to be encompassed by the present invention.

In the following description of various embodiments, reference is made to the accompanying drawings, which form a part hereof, and in which is shown, by way of illustration, various embodiments in which the invention may be practiced. It is to be understood that other embodiments may be utilized and structural and functional modifications may be made without departing from the scope and spirit of the present invention.

Moreover, it should be understood that various connections are set forth between elements in the following description; however, these connections in general, and, unless otherwise specified, may be either direct or indirect, either permanent or transitory, and either dedicated or shared, and that this specification is not intended to be limiting in this respect.

The present disclosure provides details regarding the possibility and implementation of Frequency Modulated (FM) broadcast radio integrating real-time localized media content on devices such as personal computers, tablet computers, mobile phones and other devices including the ability to broadcast such FM broadcast radio. Such devices include what have become referred as smartphones (e.g., an iPhone® or Android® mobile phone) a MP3 player (such as an iPod®), a tablet device (such as an iPad®), or other computing device that receives and plays broadcast FM radio audio. Thus, if the user's device has a display it could also show video or pictures in concurrence with the localized audio.

Thus, it should be appreciated that user devices that may used in conjunction with the disclosed embodiments include mobile phones that provide the functions of a Personal Digital Assistant (PDA) and a mobile phone. Such devices also typically serve as portable media players, web browsers that can access and properly display standard web pages and mobile broadband access. Although the term “smartphone” is usually used to describe phones with more advanced computing ability and connectivity than a contemporary feature phone, there is no official distinction or definition for what constitutes the difference between them. Thus, it should be understood that the presently disclosed embodiments may be utilized with various types of mobile devices that are personal in nature to a particular user including mobile phones that provide various features.

In accordance with at least one disclosed embodiment, a device application, e.g., software, is configured to integrate and interact with communication from one or more FM radio broadcast receivers and locally stored media content. Such locally stored media content may include, for example, localized advertising and information services based on geographical location.

Attention should be directed to U.S. patent application Ser. No. 13/626,969, filed Sep. 26, 2012, entitled “Equipment, System And Methodologies For Transmitting Localized Auxiliary Information And RDS/RBDS Information Via Multiple RF Frequencies, RF Power, And Antenna Selection Of Boosters In A Segmented Listening Area Delivering Localized Auxiliary Information,” which is a continuation-in-part application of U.S. patent application Ser. No. 13/245,482, filed Sep. 26, 2011, which is a continuation-in-part application of U.S. patent application Ser. No. 12/879,081, filed Sep. 10, 2010, which relies for priority on U.S. Provisional Patent Application Ser. No. 61/241,790, filed Sep. 11, 2009, entitled “Equipment, System And Methodologies For Segmentation Of Listening Area Into Sub-Areas Enabling Delivery Of Localized Auxiliary Information,” and U.S. Provisional Patent Application Ser. No. 61/368,509, filed Jul. 28, 2010, entitled “Equipment, System And Methodologies For Segmentation Of Listening Area Into Sub-Areas Enabling Delivery Of Localized Auxiliary Information,” the disclosures of which are all being incorporated by reference in their entireties.

These patent applications describe various implementations for providing the ability to enable targeted radio broadcast delivery in a radio broadcast area. As explained in those applications, radio broadcasters obtain revenue by selling advertising commercial time, wherein the commercials, or “spots” are incorporated into the content broadcast by the radio broadcaster in broadcasting listening area. Typically, such broadcasters' listening areas are associated with a metropolitan area or geographic region and commercial time is sold to advertisers within that area or region.

However, the value of such commercial time is, in part, based on the number of listeners that are potentially hearing a commercial; nevertheless, the effectiveness of those commercials in persuading a listener to partake of an advertised product or service or visit an advertiser's location may be based, at least in part, on the availability of the advertiser's product, service or location to a listener. Thus, although a radio station listener may hear an advertiser's commercial, the likelihood that the listener may purchase the advertiser's product/service or visit the advertiser's location is at least in part based on the availability of advertiser's product/service or proximity of the advertiser's location.

Thus, those patent applications disclose details pertaining to radio broadcasting equipment that enables targeted radio broadcast advertisement delivery in an radio broadcast area wherein a plurality of radio transmitters are used to transmit broadcasting area wide programming and localized auxiliary information on a single frequency and wherein broadcasting area wide programming is transmitted by at least one of the radio transmitters and localized auxiliary information is transmitted by individual radio transmitters included in the plurality of transmitters. Furthermore, U.S. patent application Ser. No. 13/245,482 further discloses sharing the ability to transmit localized auxiliary information for a particular frequency by broadcasters using a plurality of frequencies so as to reduce the cost of installation and operation of that equipment.

As explained in the incorporated applications' disclosures, it should be understood that the term “radio broadcaster” is meant to include organizations and/or individuals involved in the broadcast of audio radio broadcasting area wide programming and localized auxiliary information. The term “broadcasting area wide programming” or “license coverage area” is meant to include, for example, programming content that is intended to be distributed throughout a particular broadcasting area; thus, depending on the format of the station, such programming may include, for example, talk radio programs, music programs, songs, etc. Likewise, the term “localized auxiliary information” is meant to include, e.g., advertisements, public safety information, public service information, emergency broadcast information, etc. Thus, radio broadcasters are not limited to individuals or organizations owning licenses for radio broadcasting; however, the term radio broadcaster does include such individuals or organizations.

In explaining the operation of various disclosed embodiments, description of one or more “main transmitters” and “booster transmitters” is provided. It should be understood that the term “main transmitter” encompasses a transmitter that may be, for example, the only transmitter used by a radio broadcaster in a particular radio broadcasting area or it may be the most powerful (or one of the most powerful) transmitters in the radio broadcasting area.

To the contrary, the term “booster transmitter” (which is interchangeable with the term “signal boosters”) includes low-power transmitters (relative to the maximum class of the main transmitter), which are conventionally used to improve communications in locations within the normal coverage area of a radio system where the radio signal is blocked or shielded due to natural terrain or man-made obstacles (e.g., to provide fill-in coverage but not increase the normal coverage area).

Booster transmitters can be effective in weak or no-signal areas that may be present in a radio broadcaster's area of operation; however, booster transmitters are designed so as not to extend the broadcast signal beyond a radio broadcaster's licensed broadcast area. Such booster transmitters can be used to compensate or accommodate for physical barriers to effective radio broadcast transmission, e.g., mountains, mountain ranges, steep valleys, large buildings, vegetation, etc.

In accordance with the presently disclosed embodiments, an FM broadcast radio delivery methodology includes the ability to integrate real-time (or near real-time) localized media content delivered to a user's device into FM broadcast radio content output from the user's device. Accordingly, a software application, running on the user's device integrates with content received by the device from a FM radio broadcast receiver so as to output both the FM radio broadcast content from the receiver and locally stored media content to provide localized advertising and information services based on geographical location.

Accordingly, a device application may be configured to receive or collect localized media content through a variety of data channels. For example, such localized media content may be pushed or pulled depending on the application and data channel to receive localized content (audio and/or video). Subsequent to receipt at the user's device, this localized media may be stored in the device's memory (e.g., a hard drive, memory chip, etc).

Subsequently, the software application may decode a FM radio inaudible tone and media identification code, which may trigger the application to retrieve the localized media content and insert it in place of FM audio that is being listened to by the user. If the localized media content includes video data and the user's device is capable of displaying that video data, the application may also be configured to display the video data (e.g., pictures and/or video files) via the user's device.

It should be understood that the inaudible tones used by the disclosed embodiments may include many different inaudible tones which specify selection of different localized media content, auxiliary content, etc. Thus, the inaudible tone may be decoded by a decoder present within software stored on the user's device (e.g., within software or mobile application running on the device) to determine what locally stored content is to be output in response to the tone. Accordingly the inaudible tones may each include a single tone or multiple tones provided in serial or parallel so long as the decoder is able to decode the tone(s). Moreover, differentiation between tones may also be based on the length of the tone and its composition, e.g., patterns of tones, etc.

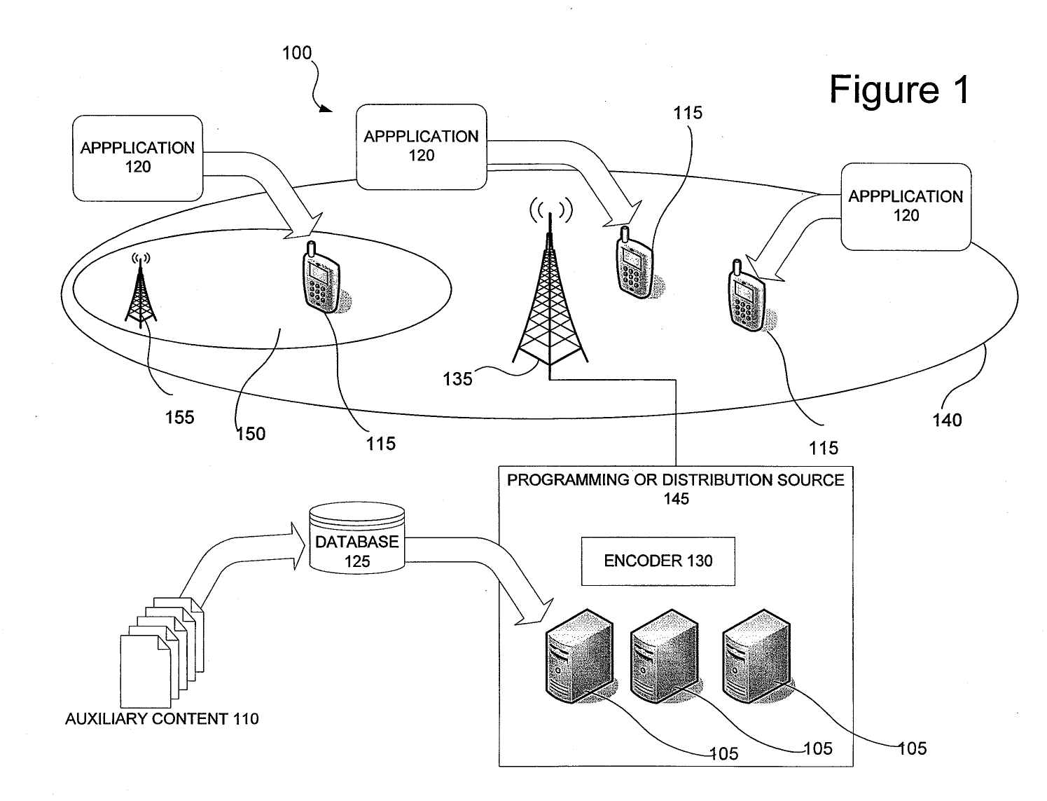

As illustrated in FIG. 1, an auxiliary content server(s) 105 collects, stores, and delivers localized auxiliary content 110 to at least one user device 115. The server(s) 105 also communicates with the application 120 running on the device 115 to determine the device's geographical location. Based on this determination, the application 120 receives downloads of localized auxiliary content 110 from the localized or focused auxiliary content server 105.

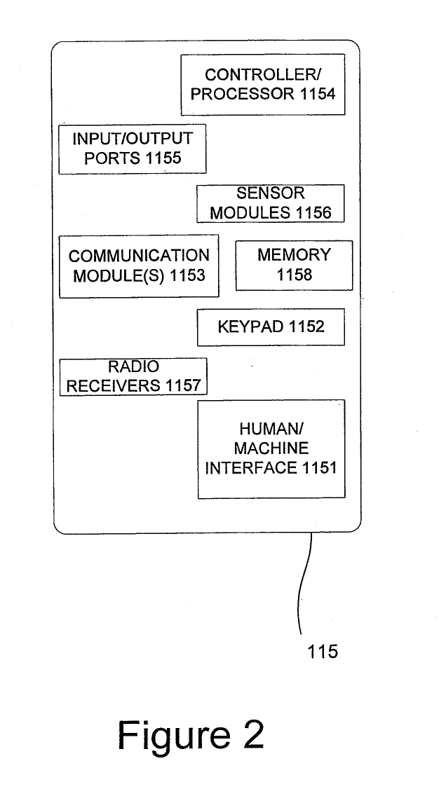

As illustrated in FIG. 2, a user's device 115 may be any of various types of mobile devices including a personal digital assistant (PDA), also known as a palmtop computer, smartphone or personal data assistant or a mobile device that functions as a mobile phone and/or personal information manager. As such, the user device 115 may have the ability to connect to the Internet.

As shown in FIG. 2, the user device 115 may include an electronic visual display 1151, enabling it to include a web browser, as well as audio capabilities enabling the device to be used as mobile phones or portable media players. The human-machine interface 1151 may include, for example, one or more speakers and microphones, buttons, and an electronic visual display that may also be configured to employ touchscreen technology, using softkeys, a directional pad, and a numeric keypad or a thumb keyboard for input to enable input of instructions and data. Alternatively, the device 115 also includes a keypad 1152 for input of information and instructions to the device 115. In association with the use of the user device 115 as a mobile phone, the device 115 may include one or more communication modules 1153 that may include, for example, antennas and software and associated hardware cooperating to receive and/or send data, information, voice, etc., along with a control module or computer processing unit 1154 configured to control operation of the constituent components of the device 115 to operate as a mobile phone, personal data organizer, media player, run various software applications, for example, to play games, etc.

Likewise, the user device 115 includes various input/output ports 1155 that enable the device to output data and instructions to other equipment, e.g., synching to a personal computer, outputting data personal head phones or speakers, or a Bluetooth interface etc. Synching with a user's personal computer allows the user to update contact, schedule, or other information on their computer, using software and have that same data transferred to the user device 115—or transfer updated information from the user device back to the computer. This eliminates the need for the user to update their data in two places. Further, the user device 115 also includes various sensor modules 1156 that enable the device 115 to interact with its surrounding by sensing its surroundings, for example, a Global Positioning System receiver and other components that enable the user device 115 to determine and register where the device is located.

The user's device 115 may also include one or more radio receivers 1157, which enable receipt of broadcast media content. That broadcast media content may be transmitted via Frequency Modulation (FM) or Amplitude Modulation (AM) or Digital broadcast.

Further, the user device 115 may include one or more memories 1158 that enable storage of data associated with the user of the device, mobile applications such as software programs, and also auxiliary content that may be transmitted and stored for later output to via the user device.

It should be understood that a software application may be downloaded and stored by the user device 115 to facilitate insertion of localized or targeted auxiliary content into an audio stream received from a radio broadcasting transmitter. Thus, the software application may be running on the user device 115 at the same time that a user is using the device 115 to listen to an FM broadcast audio stream. In response to the software application detecting an inaudible tone inserted into the audio stream, the software application may output localized or targeted auxiliary content, e.g., advertisements, announcements etc. to the user via the user device 115.

Returning to the description provided in conjunction with FIG. 1, the auxiliary content server 110 includes or is operationally coupled to one or more database(s) 125 that contains information indicating the configuration and the capabilities of user devices 115 registered with the localized media content delivery system. Such information may include but is not limited to the type, manufacturer, and model of the user device, geographical location information associated with an account associated with the user device, historical tracking information regarding previous geographical locations of the user device over a period of time (e.g., 30 days, 60 days, 6 months, etc.), distribution methods available for providing localized media content 110 to the device, a number of localized outputs via the user's device 115, etc.

The auxiliary content server(s) 105 is configured to be coupled to, interface with or incorporate an encoder 130 to communicate the appropriate inaudible tone and unique media identification code to be transmitted via a main transmitter 135 associated with a broadcasting area 140 based on the time of insertion of the localized auxiliary content 110 on the user device 115.

The encoder 130 is configured to generate and insert inaudible tones and unique media identification codes into the radio broadcast audio. The encoder 130 may be installed at a programming or distribution source 145 or coupled to it for communication and cooperation in providing the inaudible code as part of the broadcast area wide programming; thus, the encoder 130 may be configured to insert an inaudible unique media identification code into the audio stream for distributing the broadcasting area wide programming (as that term is defined in U.S. patent application Ser. No. 12/879,081).

The insertion of the inaudible code is often referred to conventionally as psychoacoustic masking, a process of modifying an audio tone or signal so listeners cannot hear the signal. The psychoacoustic tone may be detected by devices, such as user device 115, to identify and trigger a software application installed on the device 115 to play localized auxiliary content (as that term is defined in U.S. patent application Ser. No. 12/879,081) that may include, for example, advertising media associated with businesses in a localized area or zone (see, for example, 150 illustrated in FIG. 1) with the broadcasting area 140 that localized auxiliary content may be stored in the device's memory.

The inaudible unique media identification code may be used in conjunction with the geographical location to determine the stored localized auxiliary content to output via the user's device 115, when to output the content, and the duration that it should be played. It should be understood that this insertion of localized auxiliary content may be performed in such a way that a user listening to the device 115 would not register that there has been a shift between broadcast wide content and localized auxiliary content in the output audio stream. Thus, a user may be listening to a radio program or music on a particular radio station and the programming may come to a point where a user may expect a commercial break; however, rather than hearing the commercials that are being played throughout the broadcast area 140, the user hears commercials that are specific to businesses near their geographic location (e.g., 150) based on the user's location (determined by the user's device, e.g., a Smartphone or similar device).

It should be understood that the geographical location of the device 115 can be determined by a number of commonly used methods, such as by a GPS chip in the device or reception and identification of Wi-Fi signals that have known locations. Moreover, it should be understood that the application running on the device 115 may optionally request localized or focused auxiliary content (pull) or be sent localized media content (pushed) by the auxiliary content server(s) 105. This transmission may be performed in conjunction with receipt of the inaudible unique media identification code (in real-time, near real-time or at a point in time some period prior to the time point that the localized auxiliary content is to be output in the audio stream or at some point unrelated to the point in time that the localized auxiliary content is to be output via the user's device 115). This content can be delivered to the device application by a number of methods, including a 4G data cellular channel, and 3G cellular data channel, a Wi-Fi data channel, satellite, etc. or by wired connection to the Internet or other physically wired transmission media, e.g. during a synchronization event or process with an associated personal computer.

Alternatively, or in addition, the device may receive localized auxiliary content within the radio broadcast audio stream using auxiliary information such as Radio Data System (RDS), Subsidiary Communications Authorization (SCA) subcarriers, or MSN Direct™.

Using the RDS (or Radio Broadcast Data System (RBDS), which is the U.S. version of RDS) communications protocol standard, the localized auxiliary content and/or instructions for downloading or outputting the content may be embedded as small amounts of digital information in conventional FM radio broadcasts. RDS conventionally standardizes several types of information transmitted, including time, station identification and program information. Thus, localized auxiliary content and/or instructions downloading and/or outputting the content could also be included in the digital information embedded in the FM radio broadcast information.

In accordance with at least one disclosed embodiment, RDS/RBDS may be used as a source for distributing localized/auxiliary content (or alternatively, Wi-Fi, 4G, etc.). Moreover, metadata (e.g., for content tagging, including contact information—phone #, web address, etc.) may be transmitted over RDS/RBDS in conjunction with an inaudible tone trigger. Thus, in accordance with at least one disclosed embodiment, various specific inaudible tones could be associated to specific RDS data that is transmitted before or during the trigger event. In addition, technology incorporated by reference in the incorporated patent applications may enable an increase in signal level of a composite FM spectrum, which in turn may enable more reliable demodulation of an RDS subcarrier. Additionally, if disclosed embodiments are used in a broadcast area that includes multiple transmission locations (e.g., the use of auxiliary transmitters/boosters), the disclosed embodiments may enable the transmission and receipt of unique RDS data, allowing for localization and increased efficiency overall.

Likewise, SCA subcarriers may be used to transmit the localized auxiliary content and/or instructions for downloading or outputting the content.

Furthermore, using content and instructions may be delivered to a user's device 115 using a service like MSN Direct™, which is an FM radio-based digital service that enables portable devices to receive information from server-hosted services. Devices that support MSN Direct include wristwatches, desktop clocks, in-car GPS satellite navigation units, etc. Information available through paid “channels” includes weather, horoscopes, stocks, news, sports results and calendar notifications.

In accordance with the disclosed embodiments, the localized media content can be uploaded onto one or more localized or focuses auxiliary content servers 105. Subsequently, at an appropriate time, the content server 105 may download the localized or focused auxiliary content to each device in a database by one or more appropriate distribution methods (4G, Wi-Fi, etc.). Alternatively, the content server (s) 105 could respond to queries from devices by serving (e.g., downloading) the localized media content to the user device(s). In response to transmission of the localized media content, the user device may transmit (if the device is capable of two-way transmission) a signal indicating that the content was received without any errors following confirmation of the integrity of the received data. If it is determined that the localized media content includes one or more errors, or the device is powered off or out of range, the auxiliary content server(s) 105 can attempt to redeliver the content until it is successfully delivered, or the device application can realize it did not receive the content and request it.

Once the user device receives the localized media content and acknowledges error free receipt of the content (if possible), the media distribution server receives the notification. Subsequently, based on data received from the within a radio station's broadcast audio stream and/or on time of day, that it is time for devices in the database to insert stored localized media content (from the device memory) in the FM audio path on the device. The localized auxiliary server 105 communicates with the encoder and the encoder inserts inaudible tones and unique media identification code into the FM broadcast audio.

Thus, a device application configured to output the FM radio broadcast from the radio broadcaster receives and decodes the inaudible tones and unique media identification codes from the FM broadcast signal it is tuned to. The application then mutes the FM broadcast audio stream and outputs the localized auxiliary content (audio and/or video) for the proper duration.

After the localized auxiliary content is output, the FM broadcast audio is unmuted and normal operation resumes. If the device has two-way transmission capabilities it can send an acknowledgement back to the auxiliary content server(s) that the localized auxiliary content was successfully played. The acknowledgement can occur following completion of the output or at predetermined times, such as after the next download of localized auxiliary content, during a period of low traffic (such as late at night), etc. This notification enables radio broadcasters to maintain records indicating the output of what localized auxiliary content occurred at what time and in what amounts; such information may be useful in supporting advertising costs or revenue.

It should be understood that the presently disclosed embodiments may be implemented in combination, included in, or include various other technical innovations to provide improved utility to end users, content providers, broadcasters, advertisers, etc.

For example, U.S. Pat. No. 8,249,497 (the disclosure of which being incorporated herein in its entirety) to Ingrassia et al. and entitled “SEAMLESS SWITCHING BETWEEN RADIO AND LOCAL MEDIA,” discloses at 2:1-10, that electronic devices can identify current and future media items to be broadcast using any suitable approach. Ingrassia goes on to disclose that in some embodiments of its disclosed innovation, an electronic device can identify specific media items, broadcast segments, or broadcast elements from metadata broadcast along with the media items (e.g., Radio Data System, or RDS data), broadcast listings or schedules available from or published by one or more media sources, analysis of the audio or video provided by the content source (e.g., audio analysis to identify a song or voice), or any other approach.

In accordance with the presently disclosed embodiments, such “other” approaches may include the presently disclosed innovation, wherein at least some portion of auxiliary content is output to a user via the at least one user device in response to receipt of an inaudible tone included in a broadcast audio stream thereby interrupting output of a received, broadcast audio stream for a specified period of time.

In such an implementation, an inaudible tone may be used in an RF, terrestrial broadcast of an audio signal to provide a switching protocol that enables switching of device output from a broadcast stream to a local media stream and vice versa.

Ingrassia discloses that one potential mechanism for implementing switching between to local media output is based on the used of RDS. The used of RDS is discussed above and in greater detail in incorporated U.S. patent application Ser. No. 13/626,969, filed Sep. 26, 2012, entitled “Equipment, System And Methodologies For Transmitting Localized Auxiliary Information And RDS/RBDS Information Via Multiple RF Frequencies, RF Power, And Antenna Selection Of Boosters In A Segmented Listening Area Delivering Localized Auxiliary Information.”

Ingrassia further discloses at 6:29-33, that a radio station 310 can broadcast radio station information such as Radio Data System (RDS) information, which can include, for example, digital information such as station identification, the current song's track, artist, genre, and length information, and/or alternative frequencies for particular stations. Ingrassia, at 7:8-13, further discloses that the electronic device can identify a broadcast media item or segment using any suitable approach. For example, the electronic device can monitor each radio station and retrieve 10 data describing each broadcast media item (e.g., identified from an analysis of the broadcast audio, or from metadata broadcast with the media, such as RDS, RT or RT+data). Ingrassia, at 7:41-54, also teaches that, in some embodiments, the electronic device can continue to monitor the media broadcast from which the device switched to determine whether the broadcast includes a media item or segment that is of interest to the user. For example, the electronic device can monitor RDS data provided by the radio station and received by the radio tuning circuitry as a background process to determine whether the next media item is of interest. Because RDS data can be received within a window (e.g., a 10 second window) of the beginning of a media item, the electronic device can instead or in addition analyze the received audio stream to detect changes in tempo, pauses, a DJ voice, or other characteristic elements that separate consecutive media items or segments. The electronic device can then return to the media broadcast as soon as the subsequent media item is of interest.

Ingrassia at 10,14-17, discloses that an electronic device can identify an upcoming media item or segment of the received media broadcast. For example, the electronic device can monitor RDS data or data retrieved from a remote source, for the identity of one or more of the upcoming media items or segments. Furthermore, Ingrassia, at 11, 2-7, discloses that the electronic device can determine whether an upcoming media item of the monitored media broadcast is of interest to the user. For example, the electronic device can monitor RDS data, or data retrieved from a remote source, for the identity of one or more of the upcoming media items or segments.

Furthermore, in accordance with presently disclosed embodiments, the use of an inaudible tone for switching between local and broadcast content can be aided with various other conventionally known technology. For example, as disclosed in Majarajh, (United States Patent Application 20080207137; the disclosure of which being incorporated herein in its entirety) software, e.g., a mobile application, provided in accordance with the disclosed embodiments may also use metadata or some type of electronic mail or text messaging as well as have the ability to identify a mobile device geographic location empirically or in relationship to various locations (e.g., retail store locations, points of interest, etc.) and be able to output specific advertising content to the user based on the determined location and, optionally, based on a user's stored profile that may indicate interests, hobbies, demographic information etc. regarding the user. Thus, by implementing various features disclosed in Majarajh, the user of the mobile device may be presented with content recommendations and may be presented with targeted advertising content.

Thus, the innovations of Hellman (United States Patent Application 20100255772; the disclosure of which being incorporated herein in its entirety) may optionally be used to deliver alternative content based, for example, on a database of user preferences, location, demographics, etc. Thus, using various features of Hellman, advertising content may be customized for and directed to different demographic markets; accordingly, when a playlist specifies a commercial is to be played, it can specify different commercials to be played to different demographic groups, with the demographic group being stored in the playback device. For example, if the demographic information is the user's zip code, a user from a wealthy zip code can be given more commercials for brokerage houses, banking opportunities, etc. while a user from a less wealthy zip code can be given more commercials for discount stores, debt consolidation services, etc. Demographic information can also include, for example, purchasing decisions of the user, web sites visited by the user, web searches performed by the user (e.g., obtained from Google), his credit history, and feedback from the receiver to the broadcaster on the listening habits of the user.

Similarly, various features of Bull (United States Patent Application 20100010648; the disclosure of which being incorporated herein in its entirety) for a station auto tuning mode.

Similarly, various methodologies may be used for selecting what content stored or alternative content is to be output rather than the broadcast radio signal. See, for example, United States Patent Application 20060058997 of Wood, United States Patent Application 20070250597 of Resner, United States Patent Application 20070286169 of Roman, United States Patent Application 20100268361 of Mantel, which are all incorporated by reference in their entireties.

Thus, it should be understood that the presently disclosed embodiments' use of an inaudible tone included in a broadcasted audio stream to trigger output of localized auxiliary content (whether it be previously stored in a user's device or transmitted separately to the user's device) does not prevent the use of other conventionally known features for selecting the localized auxiliary content to be output. Moreover, use the presently disclosed inaudible tone embodiments enables the ability to combine various conventionally known features in new, meaningful and more effective ways.

While this invention has been described in conjunction with the specific embodiments outlined above, it is evident that many alternatives, modifications and variations will be apparent to those skilled in the art. Accordingly, the various embodiments of the invention, as set forth above, are intended to be illustrative, not limiting. Various changes may be made without departing from the spirit and scope of the invention.

For example, as explained in U.S. patent application Ser. No. 12/879,081, a segmented listening area may be configured to deliver localized auxiliary information and may utilize “zones” within the FCC defined service area of a FM broadcast transmitter associated with a particular broadcaster (see, for example, zone 150 within broadcast area 140, as illustrated in FIG. 1). These zones may contain 1 to N number of on-channel, same frequency boosters (see, for example, booster transmitter 155 associated with zone 150) that broadcast, in a simulcast manner, during specific instances in time.

For example, localized auxiliary content may be associated with a particular user's location but also based on a user's election to register with a service that provides group-based coupons or specialized or reduced rate services or products for a limited period of time. Therefore, localized auxiliary content may include audio associated with a limited time offer for a coupon service, video or graphics, e.g., a bar code that may be accessible or displayed on a screen or delivered in an email and may be scanned by a retailer or service provider to take advantage of an offering. Likewise, video may be output to the user.

Alternatively, or in addition, the service could be set up to automatically output localized auxiliary content to a user via the user device regarding coupon or reduced-rate services or products for business locations near the location of the user device. That localized auxiliary content may optionally output via text message, email or web-linkage so as to not interfere with the user's listening to the audio stream broadcast by the radio broadcaster.

Additionally or alternatively, it should be understood that the provisioning of localized auxiliary content and delivery of that content to user's devices may be shared by more than one radio broadcaster on more than one station. Therefore, multiple broadcasters could cooperate together to provide specialized advertising to user's who elect to opt in for a particular type of localized auxiliary content. For example, a user could opt in for a service where only Spanish language commercials are played. Alternatively, a service may be provided where a user is able to request advertising of particular interest to a particular age group (for example, under thirty years old or over fifty years old), a particular demographic (parents of children under ten), of a particular political persuasion (e.g., republican, democrat, tea party, libertarian, etc.) or other persuasion or affiliation (e.g., LBGT, religious affiliation, sports team fan, etc.). As a result of self identifying one's self as interested in a particular interest or type of advertising, the user can receive auxiliary content (that may or not be localized based on the user's particular location at a given moment) that is of interest to the user. For example, a mother of three children under the age of ten may received targeted radio advertizing related to activities in the metropolitan area where she lives that would be of interest to her children and/or herself. A football fan in a particular city may receive advertising

It should also be understood that the presently disclosed embodiments may be used with personal computers outputting television broadcasts and/or digital video recorders to insert locally stored content in response to the transmitted inaudible tone. Furthermore, it should that, at least in such implementations, the inaudible tone may be replaced by one or more of various other transmitted data, e.g., data packet header data, meta data, etc., as disclosed herein and within the incorporated patent applications and patents. Further, it should be understood that this transmitted trigger could also or alternatively, trigger display of broadcast content when stored content is being output to a user. Such an implementation may have particular utility if, for example, a user is listening to or viewing stored content but their personal safety requires that they be informed of a weather, terrorist or natural disaster emergency. In such a situation, the transmitted trigger could result in display of broadcast data regarding the emergency and, potentially identified by transmitted RDS/RBDS data so as to enable auto tuning to a broadcast channel/station with relevant information. Alternatively, the trigger could result in display of an alert tone or symbol that would alert the user that they may/should switch from output of stored content to presently broadcast content pertaining to an actual or potential emergency warning/watch.

Additionally, it should be understood that the functionality described in connection with various described components of various invention embodiments may be combined or separated from one another in such a way that the architecture of the invention is somewhat different than what is expressly disclosed herein. Moreover, it should be understood that, unless otherwise specified, there is no essential requirement that methodology operations be performed in the illustrated order; therefore, one of ordinary skill in the art would recognize that some operations may be performed in one or more alternative order and/or simultaneously.

Various components of the invention may be provided in alternative combinations operated by, under the control of or on the behalf of various different entities or individuals.

Further, it should be understood that, in accordance with at least one embodiment of the invention, system components may be implemented together or separately and there may be one or more of any or all of the disclosed system components. Further, system components may be either dedicated systems or such functionality may be implemented as virtual systems implemented on general purpose equipment via software implementations.

Although the utility of various invention embodiments has been described in connection with the distribution of promotional content, it should be understood that distributed information is not limited to promotional content but may also or alternatively include non-promotional material.

As a result, it will be apparent for those skilled in the art that the illustrative embodiments described are only examples and that various modifications can be made within the scope of the invention as defined in the appended claims.

What is claimed is:

1. Radio broadcasting equipment for providing targeted auxiliary content delivery in a radio broadcast area, the equipment comprising:
at least one server configured to transmit auxiliary content to at least one user device for storage within a memory of the at least one user device; and
at least one encoder configured to insert an inaudible tone into an audio stream transmitted via at least one transmitter within the radio broadcast area,
wherein at least some portion of the auxiliary content is output to a user via the at least one user device in response to receipt of the inaudible tone in the audio stream thereby interrupting output of the audio stream for a specified period of time.

2. The equipment of claim 1, wherein the auxiliary content includes at least one of advertisements, public safety information, public service information, emergency broadcast information.

3. The equipment of claim 1, further comprising the at least one transmitter, wherein the at least one transmitter is one of a plurality of transmitters that transmit analog radio signals.

4. The equipment of claim 1, further comprising the at least one transmitter, wherein the at least one transmitter is one of a plurality of transmitters that transmit digital radio signals.

5. The equipment of claim 1, the auxiliary content includes audio data spoken in a language other than a predominant language spoken in the radio broadcast area.

6. A method of providing targeted radio broadcast advertisement delivery in a radio broadcast area, the method comprising:
transmitting auxiliary content to at least one user device for storage within a memory of the at least one user device; and
inserting an inaudible tone into an audio stream using an encoder, wherein the stream is to be transmitted via at least one transmitter within the radio broadcast area,
wherein at least some portion of the auxiliary content is output to a user via the at least one user device in response to receipt of the inaudible tone in the audio stream thereby interrupting output of the audio stream for a specified period of time.

7. The method of claim 6, further comprising transmitting the audio stream with the inaudible tone via the at least one transmitter.

8. The method of claim 6, wherein the auxiliary content is transmitted to the at least one user device via the Internet.

9. The method of claim 6, wherein the auxiliary content is transmitted to the at least one user device via Wi-Fi.

10. The method of claim 6, further comprising triggering transmission of the auxiliary via transmission of the audio stream including the inaudible tone.

11. The method of claim 6, wherein the auxiliary content includes at least one of advertisements, public safety information, public service information, emergency broadcast information.

12. The method of claim 6, wherein the at least one transmitter is one of a plurality of transmitters that transmit analog radio signals.

13. The method of claim 6, wherein the at least one transmitter is one of a plurality of transmitters that transmit digital radio signals.

14. The method of claim 6, wherein the auxiliary content includes audio data spoken in a language other than a predominant language spoken in the radio broadcast area.

15. A software application running on a computer, the software application including computer implemented instructions that, when executed, enable the software application to:
receive auxiliary content and store the auxiliary content within a memory of the computer;
receive an audio stream broadcast in a radio broadcast area, the audio stream including an inaudible tone and decode the audio stream and the inaudible tone; and
output stored auxiliary content from the memory based on the decode inaudible tone so as to interrupt output of the audio stream received by the computer and output at least some portion of the stored auxiliary content to a user via the computer for a specified period of time.

16. The software application of claim 15, wherein the auxiliary content is received by the computer via the Internet.

17. The software application of claim 15, wherein the computer is a mobile device.

18. The software application of claim 15, wherein the auxiliary content is received by the computer via Wi-Fi.

19. The software application of claim 15, wherein the auxiliary content includes at least one of advertisements, public safety information, public service information, emergency broadcast information.

20. The software application of claim 15, wherein the audio stream that the decoder decodes is digital radio.

21. The software application of claim 15, wherein the audio stream that the decoder decodes is analog radio.

22. The software application of claim 15, wherein the auxiliary content includes audio data spoken in a language other than a predominant language spoken in the radio broadcast area.

23. A mobile device configured to output a received audio stream broadcast in a radio broadcast area, the mobile device comprising:
means for receiving auxiliary content for storage within a memory of the mobile device;
a transceiver that receives an audio stream broadcast in a radio broadcast area, the audio stream including an inaudible tone, the transceiver including a decoder that decodes the audio stream and the inaudible tone; and
an output device that outputs the stored auxiliary content from the memory based on the decoded inaudible tone so as to interrupt output of the audio stream received by the mobile device and output at least some portion of the stored auxiliary content to a user via the mobile device for a specified period of time.

24. A mobile device configured to output a received content stream, the mobile device comprising:
a means for receiving auxiliary content for storage within a memory of the mobile device;
a transceiver that receives a content stream broadcast in a broadcast area, the content stream including an inaudible tone, the transceiver including a decoder that decodes the content stream and the inaudible tone; and
an output device that outputs the stored auxiliary content from the memory based on the decoded inaudible tone so as to interrupt output of the content stream on the mobile device with output of at least some portion of the stored auxiliary content to a user via the mobile device for a specified period of time.
